(19) United States
(12) Patent Application Publication
(10) Pub. No.: US 2018/0218622 A1
(43) Pub. Date: Aug. 2, 2018

(54) METHOD AND APPARATUS FOR MENTALLY STIMULATING A PERSON WITH A MENTAL DISABILITY

(71) Applicant: Aishling Dalton-Kelly, Orland Park, IL (US)

(72) Inventor: Aishling Dalton-Kelly, Orland Park, IL (US)

(21) Appl. No.: 15/419,022

(22) Filed: Jan. 30, 2017

(51) Int. Cl. G09B 1/02; G09B 19/00

(52) U.S. Cl. CPC G09B 1/02; G09B 19/00

(57) ABSTRACT

A method for a person with a mental disability to mentally stimulate him-/herself. The method includes the steps of: obtaining an apparatus having a flexible sheet configured to be placed conformingly against a region of the person's body, the apparatus further having at least one device at a first location on the flexible sheet and configured to be manipulated to thereby be changed between first and second different states; placing the apparatus in an operative position against the person wherein: a) the sheet conforms to a first region of the person's body; and b) the device is situated so that the person can engage at least a part of the device with at least one of the person's limbs; and with the at least one of the person's limbs repeatedly changing the at least one device back and forth between the first and second states with the apparatus in the operative position. The invention is also directed to the apparatus used in the method.

### BACKGROUND OF THE INVENTION

### Field of the Invention

This invention relates to an apparatus, and a method for using the apparatus, to allow a person with a mental disability to mentally stimulate him-/herself.

### Background Art

Worldwide, a large number of persons have a range of different conditions that impair their mental faculties. Some of these conditions are brought about through natural aging, while others are experienced in earlier stages of life.

It is known to slow the progression of mental degenerative diseases by keeping persons mentally stimulated. Therapies commonly include mentally challenging activities and physical activities that mentally challenge and/or promote physical dexterity.

At some point, therapy is viewed as offering diminishing returns for persons with advanced stages of mental disability or deterioration. These persons are often neglected in professional facilities and homes and as a result they often go day-to-day with few challenges, on either a mental or a physical level. As a result, persons in this category often reach the point that they have a poor quality of life and have no stimulation that either energizes them on a daily basis or maintains or improves their mental acuity.

This problem becomes even more pronounced as the Baby Boom generation ages and a large percentage of persons statistically will be in the category of having some form of mental challenge. Resources for treatment and therapy are currently limited for the existing population with mental disabilities or deterioration. As numbers grow, the financial burden on public and private institutions, and in residential settings, will grow considerably.

There has been a need, and will be an increasing need, to offer persons with mental disability or deterioration some sort of activity that will maintain their mental acuity level, if not increase the same, or at least offer them a quality of life that makes day-to-day activities challenging and enjoyable.

### SUMMARY OF THE INVENTION

In one form, the invention is directed to a method for a person with a mental disability to mentally stimulate him-/herself. The method includes the steps of: obtaining an apparatus having a flexible sheet configured to be placed conformingly against a region of the person's body, the apparatus further having at least one device at a first location on the flexible sheet and configured to be manipulated to thereby be changed between first and second different states; placing the apparatus in an operative position against the person wherein: a) the sheet conforms to a first region of the person's body; and b) the device is situated so that the person can engage at least a part of the device with at least one of the person's limbs; and with the at least one of the person's limbs repeatedly changing the at least one device back and forth between the first and second states with the apparatus in the operative position.

In one form, the one device is configured to be changed between the first and second states in a predetermined manner.

In one form, the one device has a button and a receiver defining an opening. The receiver is configured so that with the button withdrawn from the opening the one device is in the first state and the receiver is in one state. The receiver can be reconfigured from the one state into another state to allow the button to be pressed through the opening, whereupon the receiver reassumes the one state to block withdrawal of the button from the opening and the one device is thereby placed in the second state.

In one form, the one device is a self-contained unit that is attached to the flexible sheet.

In one form, the one device has first and second elongate flexible members that are separated with the one device in the first state and tied together with the one device in the second state.

In one form, the one device has a zipper having a slide with spaced first and second zipper tapes, each with a length. The slide and first and second zipper tapes are configured so that the slide is movable along the length of the first and second zipper tapes to selectively control an opening size between the first and second zipper tapes. The opening size is larger with the one device in the second state than with the one device in the first state.

In one form, the at least one device includes a second device that is blocked by the one device with the one device in the first state and exposed to be engaged by the person with the one device in the second state to allow the second device to be changed between its first and second states.

In one form, the second device is configured to be folded and unfolded in changing between its first and second states.

In one form, the one device has first and second parts that have cooperating hook-and-loop fastener elements that are selectively engaged and disengaged to change the one device between the first and second states.

In one form, the flexible sheet has an uninterrupted surface against which the one device is placed.

In one form, the one device is a self-contained unit that is operable independently of the flexible sheet and attached to a surface of the flexible sheet.

In one form, the at least one device consists of three devices each changeable between its first and second states in a manner different than the other two of the devices.

In one form, the flexible sheet has an uninterrupted surface against which each of the devices is placed.

In one form, the one device has first and second parts that are movable guidingly, one against the other, in changing the one device between the first and second states.

In one form, the flexible sheet has an exposed surface over an aerial extent. The flexible sheet has a single layer over substantially an entirety of the aerial extent.

In one form, the exposed surface is adorned with a theme compatible with an interest of the person.

In one form, the at least one device is configured to be related to the theme.

In one form, the flexible sheet is a fleece material.

In one form, the invention is directed to the apparatus described above.

In one form, the flexible sheet has an exposed surface that is adorned with a theme compatible with an interest of a user. The at least one device is configured to be related to the theme.

### BRIEF DESCRIPTION OF THE DRAWINGS

FIG. 1 is a schematic representation of an apparatus, according to the invention, made up of a flexible sheet and at least one device having different states that can be changed by a user;

FIG. 2 is a schematic representation of the device on the apparatus in FIG. 1 and including at least one part manipulable by a user;

FIG. 3 is a plan view of one specific form of flexible sheet as shown schematically in FIG. 1;

FIG. 4 is a partially schematic, perspective view showing a user seated in a chair with the inventive apparatus in an operative position;

FIG. 5 is a plan view of one specific form of device as shown in FIGS. 1-3 and with the device in a first state;

FIG. 6 is a view as in FIG. 5 with the device in a second state;

FIGS. 7 and 8 are plan views of another specific form of device, as shown in FIGS. 1-4, and respectively in first and second different states;

FIG. 9 is a plan view of a further modified form of device;

FIGS. 10 and 11 are plan views of a further modified form of device in first and second states, respectively;

FIGS. 12-14 are schematic representations of three additional forms of device, according to the invention;

FIG. 15 is a perspective view of a further modified form of apparatus according to the invention;

FIG. 16 is a perspective view of another specific form of device as utilized on the apparatus in FIG. 15; and

FIG. 17 is a flow diagram representation of a method for a person with a mental disability to mentally stimulate him-/herself.

### DETAILED DESCRIPTION OF THE PREFERRED EMBODIMENT

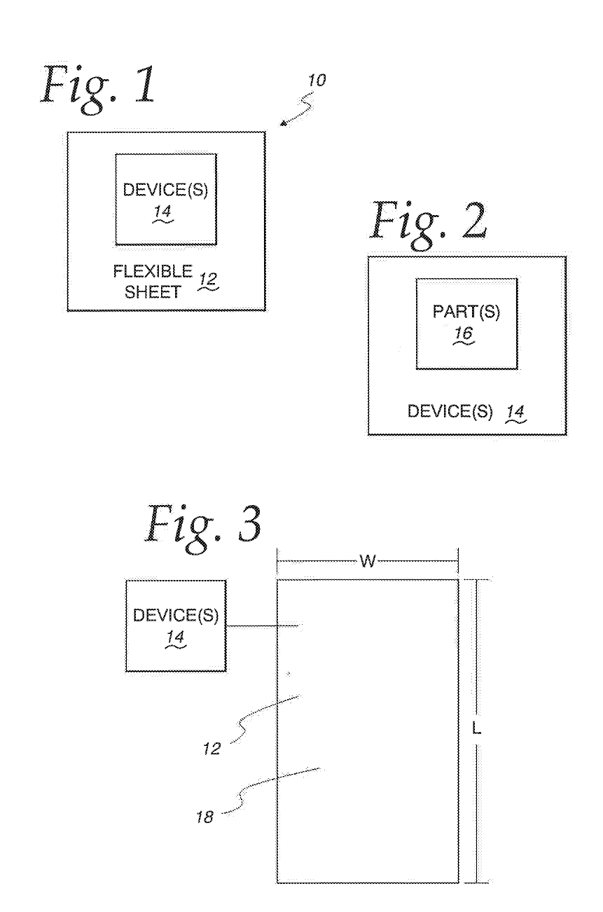

As depicted in schematic form in FIG. 1, the invention is directed to an apparatus 10 consisting of a flexible sheet 12 configured to be placed conformingly against a region of a body of a person using the apparatus 10. At least one device 14 is provided at a first location on the flexible sheet 12 and is configured to be manipulated by the person/user to thereby be changed between first and second states.

As shown in FIG. 2, also in schematic form, each device 14 consists of at least one movable/reconfigurable part 16 that can be engaged by one of the limbs of the user with the flexible sheet 12 in an operative position against the user, wherein the flexible sheet 12 conforms to a first region of the user's body. With multiple parts 16, the parts 16 are normally configured to interact with each other. This, however, is not a requirement.

Whether the device 14 consists of a single part 16 or multiple parts 16, the part(s) 16 is/are configured so that a user can effect manipulation thereof to change the device 14 back and forth between first and second states with the apparatus in the operative position.

The schematic showing of the apparatus 10 and the associated devices 14 is intended to encompass virtually an unlimited number of different constructions. The particular embodiments described below are exemplary in nature only.

Essentially, what is important in the construction of the apparatus 10 is that it lends itself to being placed in an operative position comfortably against the user and thereafter manipulated to allow the user to be both physically and mentally occupied. The nature of the devices 14 might be changed depending upon the level of a disability. Because the user's time can be occupied and the user is given a challenge, he/she may experience a better quality of life. At the same time, the activity involves enough stimulation that the user may not only slow his/her mental deterioration but may also cause a noticeable improvement in mental and/or physical condition.

As noted above, the nature of the devices 14 and the degree of difficulty in changing the same between their first and second states, can be customized to both a user's interests and capabilities. The specific exemplary forms of the devices 14 below are intended only to be representative of the multitude of different devices which would be readily devised by one skilled in the art with the present teachings in hand. All such variations are contemplated within the generic showing in FIGS. 1 and 2.

In an elementary form, as shown in FIG. 3, the flexible sheet 12 might be a single layer of material over most, or all, of its areal extent. Fleece, while not required, is highly suitable. In an alternative form, the sheet might be made from two or more layers. As depicted, the flexible sheet 12 has a rectangular shape with a length L and width W. There is no specific limitation on the length and width of the flexible sheet 12. Ideally, the overall area is selected so that the apparatus 10 can be conveniently stored, transported, and placed conformingly against a part/region of the user so that the flexible sheet 12 will remain in place without requiring the user to exert any force thereupon to maintain the same in its operative position. At the same time, with the flexible sheet 12 so situated, the devices 14 can be conveniently accessed, as with the user in a sitting position. The devices 14 are normally manipulated by the user with his/her hands.

As shown in FIG. 3, an exemplary device 14 may be a self-contained unit that is suitably attached to an uninterrupted, exposed surface 18 of the flexible sheet 12.

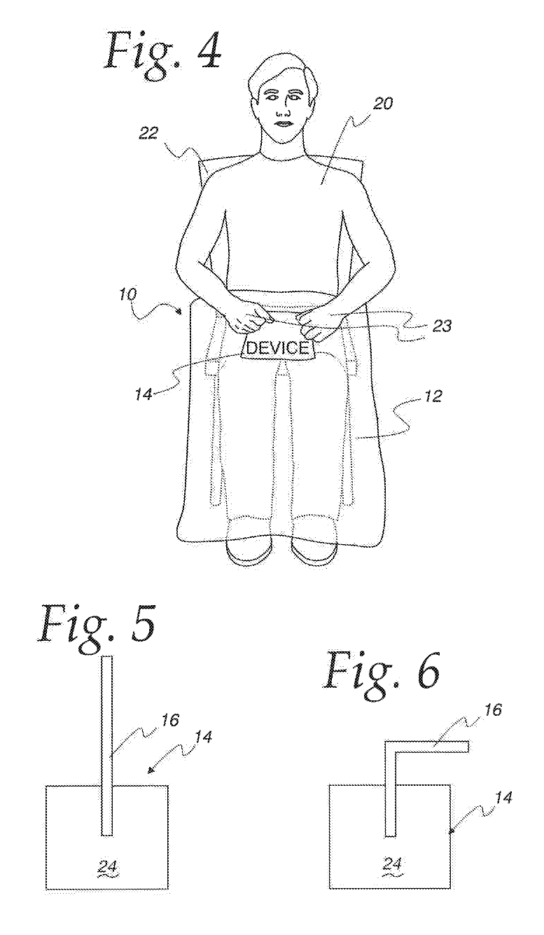

In one exemplary application, as shown FIG. 4, a user 20 may sit normally in a chair 22 with the flexible sheet 12 on the apparatus 10 operatively positioned draped over his/her lap. The flexible sheet 12 conforms to the user's waist and leg region and can be shifted so that the particular device 14, or potentially multiple devices 14, on the flexible sheet 12, are conveniently accessible to be engaged by the user's limbs—in this case, the hands 23. It is conceivable that manipulation of one or more of the devices 14 might be effected through, or assisted by, another user limb, such as the head, legs, etc. The apparatus 10 may be placed against any other region of a user's body.

In FIGS. 5 and 6, one exemplary device is shown at 14. The device 14 consists of a single part 16 that projects away from a layer 24. In the first state for the device 14, as shown in FIG. 5, the part 16 has a straight configuration. In FIG. 6, the part 16 is bent, which represents the second state for the device 14. The part 16 may have a construction such as that of a pipe cleaner to allow it to be bent and maintained in different shapes. The user may be given a shape to replicate by the bending. He/she can manipulate the part 16 to change it back and forth between the first and second states. Other shapes for the part 16 might be presented as options to the user for a second state of the device 14.

The part 16 might have weakened hinge portions to allow a user to effect reconfiguration of the part 16 in a predetermined manner.

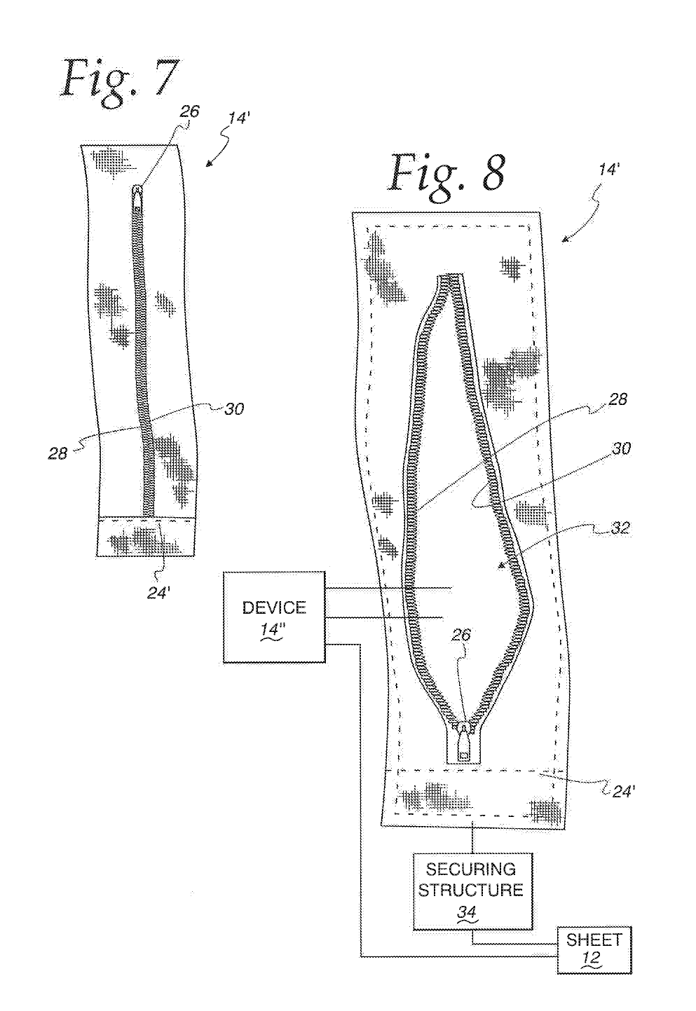

In FIGS. 7 and 8, another form of device is shown at 14′. The device 14′ is in the form of a zipper with a slide 26 and first and second zipper tapes 28, 30. The slide 26 and zipper tapes 28, 30 are configured so that the slide 26 is movable along the lengths of the zipper tapes to selectively control the size of an opening 32 between the zipper tapes 28, 30. In the first state for the device 14′, as shown in FIG. 6, the opening 32 is substantially closed, or at least smaller than the size of the opening 32 with the device 14′ in its second state, as shown in FIG. 8.

The zipper tapes 28, 30 are integrated into a layer 24′ that may be suitably secured to the sheet 12. As shown schematically in FIG. 8, any securing structure, such as an adhesive, stitching, or other structure well known to those skilled in the art, might be utilized. The securing structure 34 schematically depicted is intended to be generic to all such structures and contemplated for all of the devices 14 herein.

In one variation of the device 14′, another device 14″, attached to the layer 24′ and/or sheet 12 can be incorporated so as to be accessible through the opening 32. By changing the device 14′ into its second state, the user can manipulate the device 14″ through the opening 32. The device 14″ may in turn take many different forms.

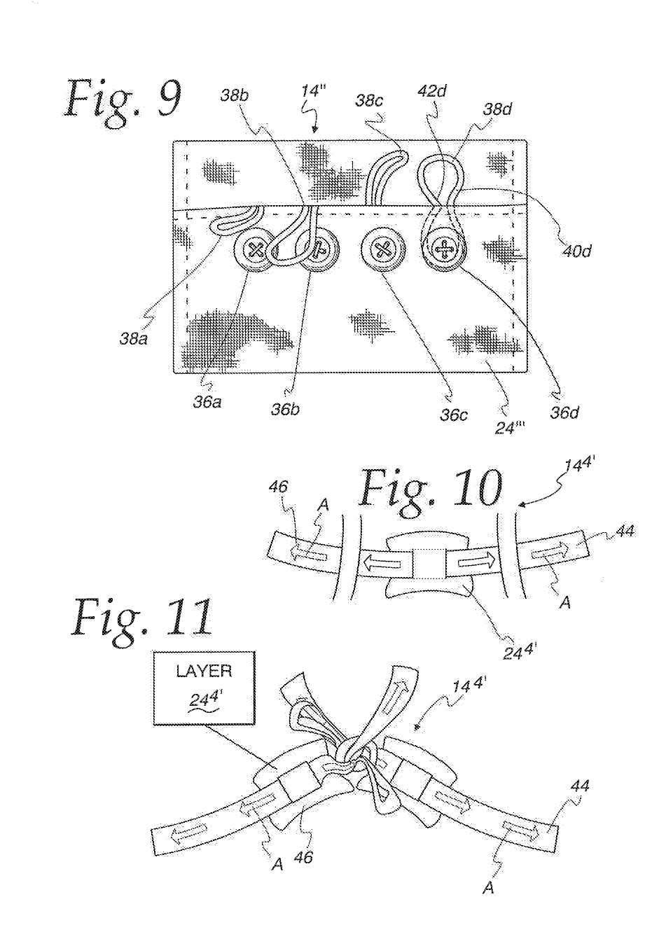

A further form of device is shown at 14′″ in FIG. 9. The device 14′″ consists of multiple buttons 36a, 36b, 36c, 36d. A corresponding number of receivers 38a, 38b, 38c, 38d are provided to cooperate one each with the buttons 36a-36d. Exemplary receiver 38d consists of a flexible cord 40d that is integrated into the layer 24′″ to define a closed loop around an opening 42d. With the button 36d withdrawn from the opening 42d, the receiver 38d is in one state. The receiver 38d can be reconfigured to another state to allow the button 36d to be pressed through the opening 42d, whereupon the receiver 38d reassumes its one state, as shown in dotted lines, to block withdrawal of the button from the opening.

The receivers 38c, 38d are integrated into the layer 24′″ to project away from their respective buttons 36c, 36d. The receivers 38a, 38b project oppositely to overlie their respective buttons 36a, 36b. Thus, a different manipulation on the user's part is required to direct the buttons into a complementary receiver opening, depending upon which of the buttons and receivers 36a, 36b; 38a, 38b or 36c, 36d; 38c, 38d is being manipulated.

A change of state of the device 14′″ results as at least one of the buttons 36a-36d is engaged with its respective receiver 38a-38d.

In FIGS. 10 and 11, a further optional form of the device is shown at 14^{4′}. The device 14^{4′} has a layer 24^{4′} into which flexible lengths 44, 46, made as from cloth, are integrated. FIG. 10 represents the first state for the device 14^{4′} wherein the lengths 44, 46 are unconnected.

In FIG. 11, representing the second state for the device 14^{4′}, the lengths 44, 46 are tied either randomly or in a prescribed pattern that may be suggested to, or facilitated for, the user. Arrows A are provided for this purpose.

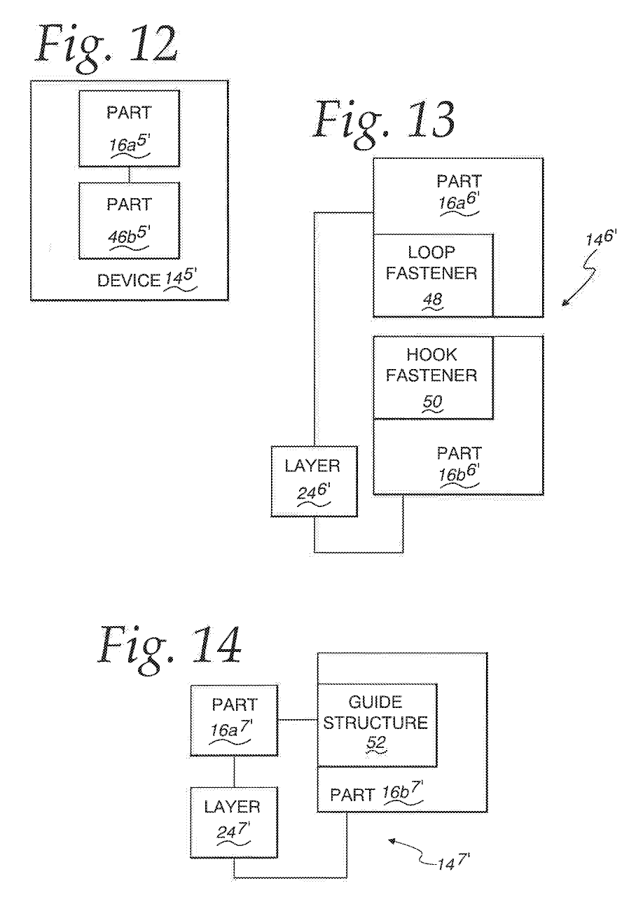

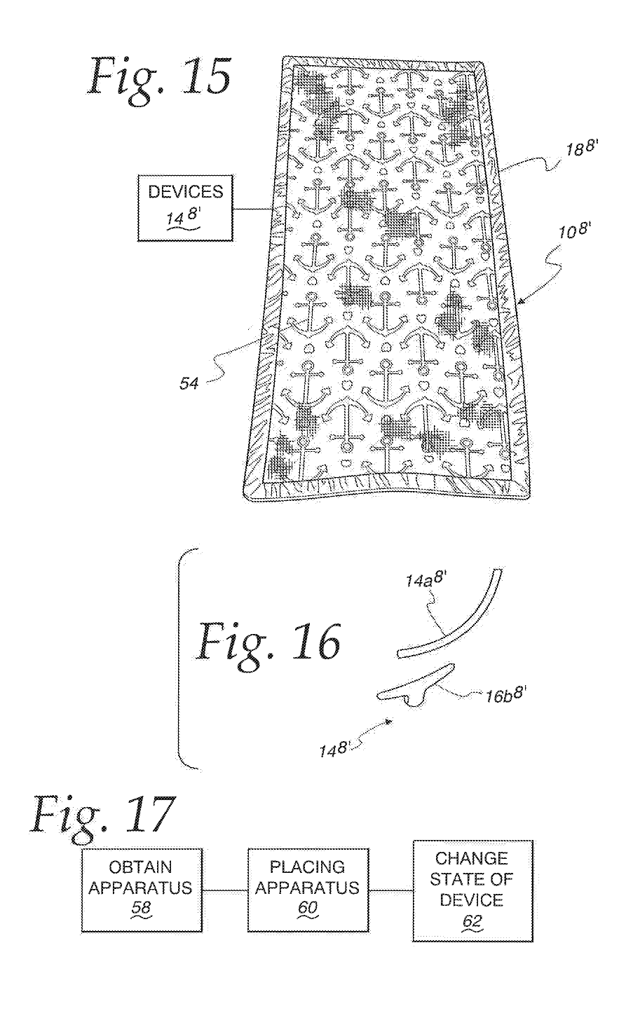

In FIG. 12, a further modified form of the device is shown schematically at 14^{5′}. The device 14^{5′} has parts 16a^{5′}, 16b^{5′} that are foldable relative to each other, either randomly or in a prescribed manner. The folding may be at hinges, weakened regions, or may be improvised by the user as permitted by a flexible layer of material that can be randomly folded. Guidance may be given to a user to direct him/her to fold in a predetermined pattern.

The device 14^{5′} may be utilized in place of the device 14″, shown schematically in FIG. 8.

In FIG. 13, a further modified form of device is shown schematically at 14^{6′}. The device 14^{6′} consists of separate parts 16a^{6′}, 16b^{6′} that are selectively joinable with each other to change the state of the device 14⁶. As depicted, the part 16a^{6′} has a loop fastener component 48 that cooperates with a hook fastener component 50 on the part 16b^{6′}. With the parts 16a^{6′}, 16b^{6′} integrated into the layer 24^{6′}, they may be manipulated to selectively engage and disengage the loop and hook fasteners 48, 50 to change the state of the device 14^{6′}. The hook and loop fastener 50, 48 may be integrated strategically to produce a specific shape with the device 14^{6′} in its second state. Alternatively, the user can randomly make connections. The parts 16a^{6′}, 16b^{6′} may have hook-and-loop fasteners 50, 48 at multiple locations, with no requirement that the “hook” and “loop” portions be on either particular part 16a^{6′}, 16b^{6′}. Repetitive engaging and disengaging of the hook-and-loop fasteners 50, 48 changes the device 14^{6′} between its first and second states.

In FIG. 14, a further modified form of device is shown schematically at 14^{7′}, consisting of cooperating parts 16a^{7′}, 16b^{7′} integrated into a layer 24^{7′}. The part 16b^{7′} has a guide structure 52 that cooperates with the part 16a^{7′} whereby the part 16a^{7′} can be advanced in a predetermined path along the guide structure 52. The guide structure 52 might be a rail, track, or other structure that permits the part 16a^{7′} to move consistently with respect to the part 16b^{7′}. A multitude of variations of this concept are contemplated. The part 16a^{7′} may move directly against the part 16b^{7′} as the state of the device 14^{7′} is changed by the user.

As noted above, the various forms of the device described herein are intended to be exemplary in nature only. Virtually any type of device that allows a user to reposition a part or parts in a repetitive fashion is contemplated. This repetitive activity allows a user to occupy a significant amount of his/her time while challenging him/herself both mentally and physically.

As noted above, there is no real restriction upon the flexible sheet 12 in terms of its construction. A fleece construction is one of many different constructions that is preferred. The flexible sheet may be made from one layer/ply or multiple layers/plies and preferably defines a single sheet that can be conveniently manipulated, transported, and operatively positioned by a user. When operatively positioned, the flexible sheet 12 comfortably drapes conformingly against the user so as not to be intrusive while at the same time presenting the various devices 14 for convenient manipulation.

Any number of the devices 14 might be utilized. A single device potentially would suffice. More preferably, at least three such devices 14 are utilized. The multiple devices preferably have different constructions so that a user must make different manipulations to change states. The use of more than three devices is also contemplated.

Each of the devices 14 might be self-contained to be operable independently of the flexible sheet 12. Alternatively, the integration into the flexible sheet 12 may make one or more of the devices 14 operable or more effectively operable.

To add another layer of interest, as shown for the apparatus 10^{8′}, the exposed surface 18^{8′} may be adorned with a theme compatible with an interest of a user. In this depicted embodiment, images of anchors 54 are incorporated into a pattern to produce a nautical theme. This may be of interest to a person who has a naval background or one that enjoys recreational boating.

Likewise, the device 14 may be configured to be compatible with this theme. As shown in FIG. 16, the device 14^{8′}, as incorporated into the apparatus 10^{8′}, has cooperating parts 16a^{8′}, 16b^{8′} respectively consisting of a rope and a dock cleat around which the user can wrap the rope 16^{8′} as is normally done in boating.

With the above described apparatus 10, a method can be practiced for a person with a mental disability to mentally stimulate him/herself as shown in flow diagram form in FIG. 17. As shown at block 58, an apparatus as described above is obtained.

As shown at block 60, the apparatus is placed in the operative position against a person wherein the sheet conforms to a first region of the person's body and a device is situated so that the person can engage at least a part of the device with at least one of the person's limbs.

As shown at block 62, the state of the device is changed back and forth between first and second states with the apparatus in the operative position.

The foregoing disclosure of specific embodiments is intended to be illustrative of the broad concepts comprehended by the invention.

1. A method for a person with a mental disability to mentally stimulate him-/herself, the method comprising the steps of:
obtaining an apparatus comprising a flexible sheet configured to be placed conformingly against a region of the person's body,
the apparatus further comprising at least one device at a first location on the flexible sheet and configured to be manipulated to thereby be changed between first and second different states;
placing the apparatus in an operative position against the person wherein: a) the sheet conforms to a first region of the person's body; and b) the device is situated so that the person can engage at least a part of the device with at least one of the person's limbs; and
with the at least one of the person's limbs repeatedly changing the at least one device back and forth between the first and second states with the apparatus in the operative position.

2. The method for a person with a mental disability to mentally stimulate him-/herself according to claim 1 wherein the one device is configured to be changed between the first and second states in a predetermined manner.

3. The method for a person with a mental disability to mentally stimulate him-/herself according to claim 2 wherein the one device comprises a button and a receiver defining an opening, the receiver configured so that with the button withdrawn from the opening the one device is in the first state and the receiver is in one state, wherein the receiver can be reconfigured from the one state into another state to allow the button to be pressed through the opening, whereupon the receiver reassumes the one state to block withdrawal of the button from the opening and the one device is thereby placed in the second state.

4. The method for a person with a mental disability to mentally stimulate him-/herself according to claim 3 wherein the one device is a self-contained unit that is attached to the flexible sheet.

5. The method for a person with a mental disability to mentally stimulate him-/herself according to claim 1 wherein the one device comprises first and second elongate flexible members that are separated with the one device in the first state and tied together with the one device in the second state.

6. The method for a person with a mental disability to mentally stimulate him-/herself according to claim 1 wherein the one device comprises a zipper comprising a slide with spaced first and second zipper tapes each with a length, the slide and first and second zipper tapes configured so that the slide is movable along the length of the first and second zipper tapes to selectively control an opening size between the first and second zipper tapes, the opening size larger with the one device in the second state than with the one device in the first state.

7. The method for a person with a mental disability to mentally stimulate him-/herself according to claim 6 wherein the at least one device comprises a second device that is blocked by the one device with the one device in the first state and exposed to be engaged by the person with the one device in the second state to allow the second device to be changed between its first and second state.

8. The method for a person with a mental disability to mentally stimulate him-/herself according to claim 7 wherein the second device is configured to be folded and unfolded in changing between its first and second states.

9. The method for a person with a mental disability to mentally stimulate him-/herself according to claim 1 wherein the one device comprises first and second parts that have cooperating hook-and-loop fastener elements that are selectively engaged and disengaged to change the one device between the first and second states.

10. The method for a person with a mental disability to mentally stimulate him-/herself according to claim 1 wherein the flexible sheet has an uninterrupted surface against which the one device is placed.

11. The method for a person with a mental disability to mentally stimulate him-/herself according to claim 1 wherein the one device comprises a self-contained unit that is operable independently of the flexible sheet and attached to a surface of the flexible sheet.

12. The method for a person with a mental disability to mentally stimulate him-/herself according to claim 1 wherein the at least one device comprises three devices each changeable between its first and second states in a manner different than the other two of the devices.

13. The method for a person with a mental disability to mentally stimulate him-/herself according to claim 12 wherein the flexible sheet has an uninterrupted surface against which each of the devices is placed.

14. The method for a person with a mental disability to mentally stimulate him-/herself according to claim 1 wherein the one device comprises first and second parts that are movable guidingly, one against the other, in changing the one device between the first and second states.

15. The method for a person with a mental disability to mentally stimulate him-/herself according to claim 1 wherein the flexible sheet has an exposed surface over an aerial extent and the flexible sheet has a single layer over substantially an entirety of the aerial extent.

16. The method for a person with a mental disability to mentally stimulate him-/herself according to claim 15 wherein the exposed surface is adorned with a theme compatible with an interest of the person.

17. The method for a person with a mental disability to mentally stimulate him-/herself according to claim 16 wherein the at least one device is configured to be related to the theme.

18. The method for a person with a mental disability to mentally stimulate him-/herself according to claim 1 wherein the flexible sheet comprises a fleece material.

19. The apparatus recited in claim 1.

20. The apparatus according to claim 19 wherein the flexible sheet has an exposed surface that is adorned with a theme compatible with an interest of a user and the at least one device is configured to be related to the theme.
